(19) United States
(12) Patent Application Publication
(10) Pub. No.: US 2024/0001543 A1
(43) Pub. Date: Jan. 4, 2024

(54) TRAINING DEVICE FOR INDICATING TRAINING POINT THROUGH DIRECT TRAINING OPERATION, ROBOT CONTROL DEVICE, AND COMPUTER PROGRAM FOR TRAINING DEVICE

(71) Applicant: FANUC CORPORATION, Yamanashi (JP)

(72) Inventors: Shintaro NIIMURA, Yamanashi (JP); Gou INABA, Yamanashi (JP)

(21) Appl. No.: 18/253,394

(22) PCT Filed: Nov. 24, 2021
(86) PCT No.: PCT/JP2021/043032

§ 371 Date: May 18, 2023

(30) Foreign Application Priority Data
Nov. 30, 2020 (JP) 2020-198890

(51) Int. Cl. B25J 9/16

(52) U.S. Cl. CPC B25J 9/163; B25J 9/1664; B25J 9/161; B25J 9/06

(57) ABSTRACT

A display unit of this robot control device displays thereon an operation program that includes a direct training operation command prior to recording of positional information of a training point. When a worker starts a direct training operation by selecting a direct training operation command, a training point setting unit sets up a training point on the basis of the position and posture of a robot that have been acquired during a period when the worker was moving constituent members of the robot. A command generation unit generates a robot operation command in which the positional information of the training point set up by the training point setting unit is recorded.

### TECHNICAL FIELD

The present invention relates to a teaching device, a robot controller, and a computer program of the teaching device, that teach a teaching point by a direct teaching operation.

### BACKGROUND ART

A robot apparatus including a robot and a working tool is driven based on an operation program. In the operation program, an operation command for driving the robot or the working tool is written with a command statement. Examples of the command statement of the robot apparatus include a command statement for moving a tool center point of the robot in a linear manner, a command statement for moving the tool center point in a curved manner, and a command statement for operating the working tool.

The operation program can be generated by an operator who operates a teach pendant. For example, the operator sets the robot at a desired position and orientation by operating the teach pendant, and the operator teaches the position and the orientation of the robot as a teaching point. The operation program can be generated based on a plurality of such teaching points.

In the prior art, it is known that in order to teach a teaching point, an operator operates a handle fixed to a wrist or the like of a robot and directly changes a position and an orientation of the robot. The operator teaches a desired position and orientation of the robot as a teaching point. An operation in which the operator teaches a teaching point by directly changing the position and the orientation of the robot is referred to as a direct teaching operation.

In the direct teaching operation, there is known control for acquiring a position and an orientation of a robot at a predetermined sampling time during a period in which an operator is changing the position and the orientation of the robot (e.g., JP 2009-072833 A). There also is known control for adding a command for a robot to wait or changing a work condition after a teaching point is set by changing the position and the orientation of the robot (e.g., JP 2018-176288 A).

### CITATION LIST

### Patent Literature

[PTL 1] JP 2009-072833 A
[PTL 2] JP 2018-176288 A

### SUMMARY OF THE INVENTION

### Technical Problem

In a direct teaching operation, when a plurality of teaching points are collectively stored, a large amount of work, such as setting parameters for determining the number and interval of teaching points and operations for starting or stopping teaching points, is required. A device according to the prior art has a problem in that screens for these operations are not organized, and therefore the operations become complicated. A teaching point that is taught serves as an operation program of a robot, but understanding the relationship between each setting and operation and a plurality of teaching points added to the operation program can be difficult.

In the direct teaching operation, the operator changes the position and the orientation of the robot by moving the component of the robot. Therefore, finely adjusting the position and the orientation of the robot is difficult. In the direct teaching operation, a rough position and orientation of the robot are designated. After teaching points are stored, the position and the orientation of the robot need to be finely modified. An operation command of the operation program includes many operation commands such as an operation command generated by the operator who operates the robot by the teach pendant, in addition to an operation command generated by the direct teaching operation. Simply viewing the operation command has a problem in that determining an operation command including teaching points set by the direct teaching operation is difficult.

For example, when a trajectory of the robot is generated, the direct teaching operation may be performed a plurality of times. The direct teaching operation may be redone in some sections after the trajectory of the robot is generated. In this case, an operation command in one section, in which the direct teaching operation has been performed, is deleted. However, there is a problem in that time is required to discriminate an operation command that includes teaching points defined by the direct teaching operation from others.

In this way, in the related art, work is complicated, and the amount of work is increased in order to perform the direct teaching operation. This results in a problem in that time is required to generate an operation program.

### Solution to Problem

A first aspect of the present disclosure is a teaching device configured to perform a direct teaching operation of allowing an operator to teach a teaching point by directly operating a robot. The teaching device includes a display part configured to display an operation program. The teaching device includes a teaching point setting unit configured to set, as a teaching point, a position and an orientation of the robot acquired during a period in which the operator is moving a component of the robot. The teaching device includes a command generation unit configured to generate an operation command included in the operation program based on the teaching point set by the teaching point setting unit. The display part displays an operation program including an operation command for direct teaching before position information of the teaching point is recorded. When the operator starts a direct teaching operation by selecting the operation program for direct teaching, the teaching point setting unit sets one or more teaching points based on the position and the orientation of the robot, and the command generation unit generates an operation command of the robot, in which position information of the teaching point set by the teaching point setting unit is recorded.

A second aspect of the present disclosure is a teaching device configured to perform a direct teaching operation of allowing an operator to teach a teaching point by directly operating a robot. The teaching device includes a display part configured to display an operation program. The teaching device includes a teaching point setting unit configured to set, as a teaching point, a position and an orientation of the robot acquired during a period in which the operator is moving a component of the robot. The teaching device includes a command generation unit configured to generate an operation command included in the operation program based on the teaching point set by the teaching point setting unit. The command generation unit generates an operation command for direct teaching which includes a plurality of operation commands of the robot based on a plurality of the teaching points set by the teaching point setting unit. The display part displays the operation command for direct teaching configured by one command statement or one command diagram.

A third aspect of the present disclosure is a computer program of a teaching device configured to perform a direct teaching operation of allowing an operator to teach a teaching point by directly operating a robot. The computer program causes a computer to execute a display function of displaying an operation program on a display part. The computer program causes the computer to execute a teaching point setting function of setting, as a teaching point, a position and an orientation of the robot acquired during a period in which the operator is moving a component of the robot. The computer program causes the computer to execute a command generation function of generating an operation command included in the operation program based on the teaching point set by the teaching point setting function. The display function includes a function of displaying, on the display part, an operation program including an operation command for direct teaching before position information of the teaching point is recorded. When the operator starts a direct teaching operation by selecting the operation program for direct teaching, the computer program causes the computer to execute the teaching point setting function of setting one or more teaching points and the command generation function of generating the operation command of the robot, in which position information of the teaching point set by the teaching point setting function is recorded.

A fourth aspect of the present disclosure is a computer program of a teaching device configured to perform a direct teaching operation of allowing an operator to teach a teaching point by directly operating a robot. The computer program causes a computer to execute a display function of displaying an operation program on a display part. The computer program causes the computer to execute a teaching point setting function of setting, as a teaching point, a position and an orientation of the robot acquired during a period in which the operator is moving a component of the robot. The computer program causes the computer to execute a command generation function of generating an operation command included in the operation program based on the teaching point set by the teaching point setting function. The command generation function includes a function of generating an operation command for direct teaching which includes a plurality of operation commands of the robot based on a plurality of the teaching points set by the teaching point setting function. The display function includes a function of displaying the operation command for direct teaching configured by one command statement or one command diagram.

A fifth aspect of the present disclosure is a robot controller configured to perform a direct teaching operation of allowing an operator to teach a teaching point by directly operating a robot. The robot controller includes a teaching point setting unit configured to set, as a teaching point, a position and an orientation of the robot acquired during a period in which the operator is moving a component of the robot. The robot controller includes a command generation unit configured to generate an operation command included in an operation program based on the teaching point set by the teaching point setting unit. The robot controller is configured to cause a display part to display an operation program including an operation command for direct teaching before position information of the teaching point is recorded. When the operator starts a direct teaching operation by selecting the operation program for direct teaching, the teaching point setting unit sets one or more teaching points based on the position and the orientation of the robot, and the command generation unit generates an operation command of the robot, in which position information of the teaching point set by the teaching point setting unit is recorded.

A sixth aspect of the present disclosure is a robot controller configured to perform a direct teaching operation of allowing an operator to teach a teaching point by directly operating a robot. The robot controller includes a teaching point setting unit configured to set, as a teaching point, a position and an orientation of the robot acquired during a period in which the operator is moving a component of the robot. The robot controller includes a command generation unit configured to generate an operation command included in an operation program based on the teaching point set by the teaching point setting unit. The command generation unit generates an operation command for direct teaching which includes a plurality of operation commands of the robot based on a plurality of the teaching points set by the teaching point setting unit. The robot controller is configured to cause a display part to display the operation command for direct teaching configured by one command statement or one command diagram.

### Advantageous Effect of the Invention

According to one aspect of the present disclosure, it is possible to provide a teaching device, a robot controller, and a computer program of the teaching device that can easily generate an operation program by teaching a teaching point by a direct teaching operation.

### BRIEF DESCRIPTION OF DRAWINGS

FIG. 1 is a schematic view of a robot apparatus according to an embodiment.

FIG. 2 is a block diagram of the robot apparatus.

FIG. 3 is an image including a first operation program displayed on a display part in the embodiment.

FIG. 4 is another image of the first operation program.

FIG. 5 is an image of a process of disposing icons in a program display region in generation of the first operation program.

FIG. 6 is an image after disposing icons in the program display region.

FIG. 7 is an image for explaining a first process of a direct teaching operation in the generation of the first operation program.

FIG. 8 is an image for explaining a second process of the direct teaching operation in the generation of the first operation program.

FIG. 9 is an image for explaining a third process of the direct teaching operation in the generation of the first operation program.

FIG. 10 is an image describing a fourth process of the direct teaching operation in the generation of the first operation program.

FIG. 11 is an image of another direct teaching icon in the embodiment.

FIG. 12 is an image of a second operation program displayed on the display part in the embodiment.

FIG. 13 is an image during a period in which a direct teaching operation is performed in generation of the second operation program.

FIG. 14 is an image of a plurality of command statements for a robot included in a command statement for direct teaching.

FIG. 15 is an image for modifying a command statement of the robot included in the command statement for the direct teaching.

FIG. 16 is an image illustrating a trajectory of the robot based on the command statement for the direct teaching.

### DESCRIPTION OF EMBODIMENTS

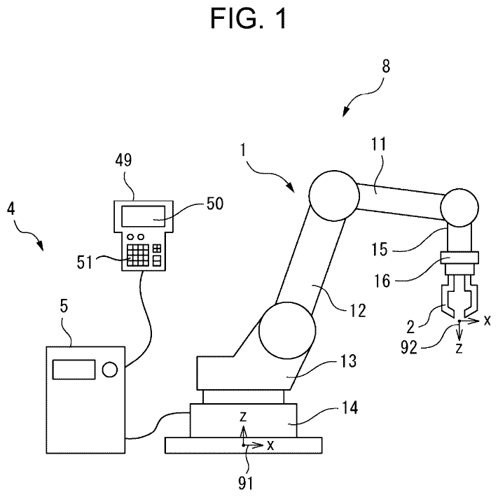

A teaching device, a robot controller, and a computer program of the teaching device that teach a teaching point of a robot in an embodiment are described with reference to FIGS. 1 to 16. In the present embodiment, a direct teaching operation is performed by an operator who teaches a teaching point by directly operating a robot.

FIG. 1 is a schematic view of a robot apparatus in the present embodiment. A robot apparatus 8 includes a hand 2 as a working tool (end effector) and a robot 1 that changes a position and an orientation of the hand 2. The robot 1 according to the present embodiment is an articulated robot including a plurality of joints.

The robot 1 includes a base part 14 fixed to an installation surface and a turning base 13 supported by the base part 14. The turning base 13 is formed so as to rotate with respect to the base part 14. The robot 1 includes an upper arm 11 and a lower arm 12. The lower arm 12 is rotatably supported by the turning base 13 via the joint. The upper arm 11 is rotatably supported by the lower arm 12 via a joint. Further, the upper arm 11 rotates about a rotation axis parallel to the extending direction of the upper arm 11.

The robot 1 includes a wrist 15 that is coupled to an end portion of the upper arm 11. The wrist 15 is rotatably supported by the upper arm 11 via a joint. The wrist 15 includes a flange 16 that is formed so as to be rotatable. The hand 2 is fixed to the flange 16. The robot 1 of the present embodiment is configured by including a plurality of components such as the base part 14, the turning base 13 and the lower arm 12. The robot 1 according to the present embodiment includes six drive shafts, but is not limited to this configuration. Any robot capable of moving the working tool can be employed.

The hand 2 of the present embodiment is a working tool for gripping and releasing a workpiece. The hand 2 grips the workpiece by closing claw parts facing each other. The working tool is not limited to the hand that grips the workpiece. Any working tool can be attached to a robot in response to a task that is performed by a robot apparatus. For example, when the robot apparatus performs arc welding, a welding torch can be attached to the robot.

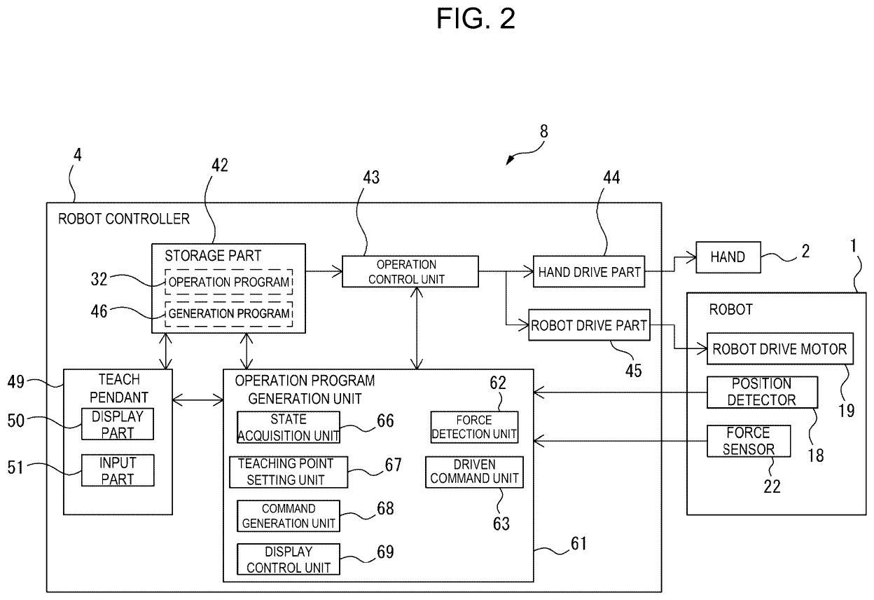

FIG. 2 is a block diagram illustrating the robot apparatus of the present embodiment. Referring to FIG. 1 and FIG. 2, the robot 1 includes a robot drive device that changes a position and an orientation of the robot 1. The robot drive device includes a robot drive motor 19 that drives the component of the robot 1. The hand 2 includes a hand drive device for driving the hand 2. The hand drive device includes a pressurizing pump, a valve, or the like for driving claw parts of the hand 2.

The robot apparatus 8 includes a robot controller 4 for controlling the robot 1 and the hand 2. The robot controller 4 includes a controller body 5. The controller body 5 includes an arithmetic processing device (computer) including a Central Processing Unit (CPU) as a processor. The arithmetic processing device includes a Random Access Memory (RAM) and a Read Only Memory (ROM), or the like, connected to the CPU via a bus. An operation program 32 includes an operation command for driving the robot 1 and the hand 2. The robot apparatus 8 is driven based on an operation program and conveys a workpiece.

The arithmetic processing device in the robot controller 4 includes a storage part 42 storing predefined information. The storage part 42 stores information related to the control of the robot 1 and the hand 2. The operation program 32 is stored in the storage part 42. The storage part 42 can be configured by a non-transitory storage medium. For example, the storage part 42 can be configured by a storage medium which can store information, such as a volatile memory, a nonvolatile memory, a magnetic storage medium, an optical storage medium or the like.

The robot controller 4 includes an operation control unit 43 that transmits a command signal. The operation control unit 43 corresponds to a processor that is driven according to the operation program 32. The operation control unit 43 is formed so as to be able to read information stored in the storage part 42. The processor serves as the operation control unit 43 by reading the operation program 32 and performing the control defined in the operation program 32.

The operation control unit 43 transmits a command signal to a robot drive part 45 for driving the robot 1. The robot drive part 45 includes an electric circuit for driving the robot drive motor 19. The robot drive part 45 supplies electricity to the robot drive motor 19 based on the command signal. The operation control unit 43 also transmits a command signal to a hand drive part 44 for driving the hand 2. The hand drive part 44 includes an electric circuit for driving the hand drive device. The hand drive part 44 supplies electricity to the hand drive device based on the command signal.

The robot controller 4 includes a teach pendant 49 configured to manually drive the robot 1. The teach pendant 49 includes a display part 50 having a display function of displaying information related to the control of the robot apparatus 8, and an input part 51 having an input function by which the operator inputs any information. The display part 50 can be configured by a display panel such as a liquid crystal display panel. The display part 50 displays the operation program 32, an image of the robot 1, or the like. The input part 51 can be configured by an input device such as a keyboard and a dial. The operator can manually adjust the position and the orientation of the robot 1 by operating the input part 51.

The display part may include a touch panel type display panel. In this case, the operator can operate the robot apparatus 8 by pressing a button displayed on the display panel. That is, the touch panel type display panel serves as a display part and an input part. The teach pendant may further include a mobile terminal such as a tablet. The robot controller 4 in the present embodiment includes the teach pendant 49, but is not limited to this configuration. The teach pendant may be disposed separately from the robot controller, and the teach pendant may be connected to the robot controller.

The robot 1 includes a position detector 18 as a state detector for detecting the position and the orientation of the robot 1. The position detector 18 of the present embodiment is attached to the robot drive motor 19 corresponding to a drive shaft of a component such as an arm. For example, the position detector 18 is formed so as to detect a rotation angle when the robot drive motor 19 drives.

A world coordinate system 91 is set in the robot apparatus 8 of the present embodiment. In the example illustrated in FIG. 1, an origin of the world coordinate system 91 is disposed on the base 14 of the robot 1. The world coordinate system 91 is also referred to as a reference coordinate system of the robot. The world coordinate system 91 is a coordinate system in which a position of the origin is fixed, and the directions of coordinate axes are also fixed.

In the robot apparatus 8, a tool coordinate system 92 having an origin set at any position of the working tool is set. The origin of the tool coordinate system 92 of the present embodiment is set at the tool center point. When the position and the orientation of the robot 1 are changed, the position of the origin and the direction of the tool coordinate system 92 are changed. For example, the position of the robot 1 corresponds to a position of the tool center point (position of the origin of the tool coordinate system 92). The orientation of the robot 1 also corresponds to the direction of the tool coordinate system 92 with respect to the world coordinate system 91.

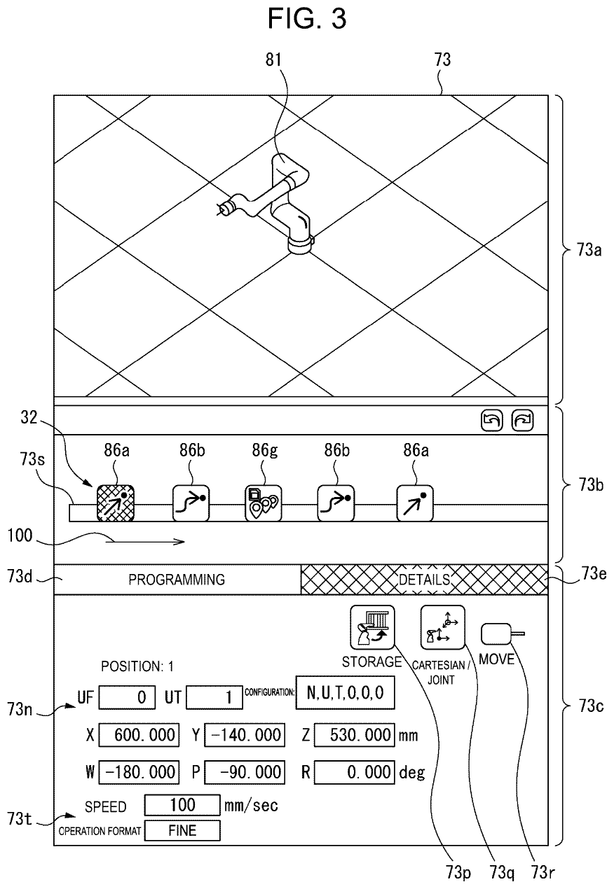

FIG. 3 illustrates an image displaying a first operation program in the present embodiment. FIG. 3 illustrates an image 73 displayed on the display part 50 of the teach pendant 49. The image 73 includes a trajectory display region 73a for displaying the trajectory of the position of the robot 1. In the trajectory display region 73a, an image 81 of the robot is displayed in a perspective view. In the trajectory display region 73a, the trajectory of the position of the robot 1 can be displayed during a period in which teaching points are acquired by the direct teaching operation. Alternatively, in the trajectory display region 73a, the trajectory of the position of the robot 1 in the operation program can be displayed.

The image 73 includes a program display region 73b for displaying an operation program and an information display region 73c for displaying information related to the operation program. A first operation program 32 is displayed in the program display region 73b. The operation program includes operation commands of the robot apparatus 8. For example, the operation programs include an operation command of the robot, an operation command of the working tool, and an operation command of an auxiliary device. The auxiliary device is a device disposed around the robot. An example of the auxiliary device may include a positioner for rotating a workpiece.

In the first operation program 32, the operation commands of the robot 1 are generated in icons 86a, 86b and 86g as command diagrams. The icons 86a, 86b and 86g are main icons indicating main operation commands of the first operation program 32. The plurality of icons 86a, 86b and 86g are displayed in line on a timeline 73s. When driving the robot 1, the respective operation commands are executed in order along the timeline 73s as indicated by an arrow 100.

The icon 86a corresponds to an operation command for changing the position and the orientation of the robot 1 so that the position of the robot 1 moves linearly. The icon 86b corresponds to an operation command for changing the position and the orientation of the robot 1 so that the position of the robot 1 moves in a curved manner. One teaching point is defined in each of the icons 86a and 86b. The first operation program 32 further includes the icon 86g as an operation command generated by the direct teaching operation. In the present embodiment, the icon generated by the direct teaching operation is referred to as a direct teaching icon.

The information display region 73c displays a tab 73d for selecting icons in generating an operating program, and a tab 73e for displaying detailed information of each icon. By selecting the tab 73e for displaying the detailed information, an operation condition for driving the robot 1 defined for each icon is displayed. In this example, the icon 86a that is the first icon corresponding to the first teaching point is designated, and the tab 73e is selected.

In the information display region 73c, a teaching point information region 73n displays the coordinate system used for defining the position and the orientation of the robot and coordinate values of the position and the orientation of the robot at the teaching point. In an operation information region 73t of the information display region 73c, a movement speed (movement speed of the tool center point) and an operation format of the robot 1 are defined. Here, the operation format, in which the trajectory of the robot passes through the first teaching point, is selected.

The operator can select items included in the teaching point information region 73n and the operation information region 73t and set or modify each of the items. For example, in the teaching point information region 73n, the position and the orientation of the robot are indicated by the coordinate values of the world coordinate system 91. The operator can set or modify the position and the orientation of the robot at the teaching point by inputting coordinate values.

In the example of the image 73 in FIG. 3, buttons 73p, 73q and 73r are further displayed in the information display region 73c. The button 73q is a button for converting the coordinate system displayed in the teaching point information region 73n. The coordinate system indicating the position and the orientation of the robot 1 can be changed. The button 73r is a button for driving the robot 1 so that the position and the orientation of the robot are at the teaching point corresponding to the selected icon 86a. The operator can check the actual position and orientation of the robot by pressing this button.

The button 73p is a button for changing and storing the position and the orientation of the robot at the teaching point. The operator can adjust the position and the orientation of the robot at the teaching point by operating the input part 51 of the teach pendant 49. When the robot 1 is in the desired position and orientation, the position and the orientation of the robot 1 are fixed by pressing the button 73p. The changed position and orientation of the robot 1 are stored in the storage part 42.

In the operation program of the present embodiment, an operation command for direct teaching can be displayed in one command statement or one command diagram. In the first operation program 32, the operation command for direct teaching is displayed in the icon 86g. The icon 86g corresponds to an operation command of the robot based on a plurality of teaching points set during the period of the direct teaching operation. The icon 86g as the operation command for direct teaching includes a plurality of operation commands such as linear movement or curvilinear movement. That is, the icon 86g collectively displays a plurality of operation commands for the robot.

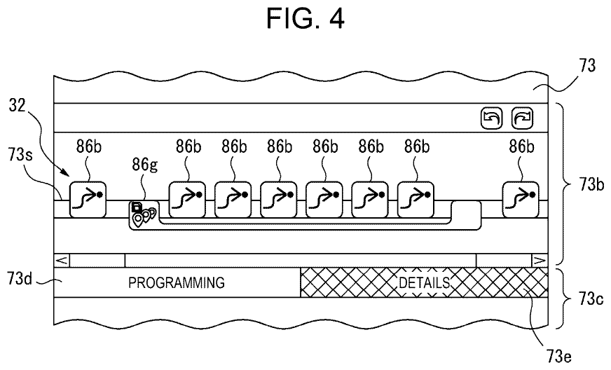

FIG. 4 illustrates an image of the first operation program when a direct teaching icon is expanded. The display part 50 can expand and display the operation command for direct teaching in response to an operation of the input part 51 by the operator. The display part 50 displays a plurality of operation commands of the robot included in the operation command for direct teaching. Here, when the operator presses the icon 86g twice in succession, the display part 50 expands and displays the icon 86g. In the present embodiment, the shape of the icon 86g is deformed from a quadrangular shape to a U shape. Then, the plurality of icons 86b of the robot corresponding to teaching points taught by the direct teaching operation are displayed in a region designated by the icon 86g. The icons 86b surrounded by the icon 86g are auxiliary icons. As will be described below, by selecting one icon 86b from the plurality of icons 86b and selecting the tab 73e displaying detailed information, detailed information of an operation command including the teaching point generated by the direct teaching operation can be displayed.

FIGS. 3 and 4 display icons as operation commands for changing the position and the orientation of the robot, but the operation commands are not limited to this configuration. The operation program may include icons for arbitrary operation commands for controlling the robot apparatus. For example, the operation program may include an icon of an operation command for driving the working tool or an operation command of an auxiliary device other than the robot and the working tool. The command diagram is not limited to an icon, and a block can be employed.

Next, a method of generating the first operation program 32 of the present embodiment will be described. The robot apparatus 8 in the present embodiment includes a teaching device with which the operator performs a direct teaching operation. In the direct teaching operation, the operator teaches a teaching point by directly operating the robot 1. The operator changes the position and the orientation of the robot 1 by pushing or pulling the components of the robot 1. For example, the operator can change the position and the orientation of the robot by directly pushing the upper arm 11 or the wrist 15 of the robot.

Referring to FIG. 2, the robot controller 4 of the present embodiment serves as a teaching device. The robot controller 4 can generate the operation program 32 for driving the robot 1 and the hand 2. The storage part 42 stores a generation program 46 for generating the operation program 32 by the direct teaching operation. The generation program 46 corresponds to a computer program of the teaching device for performing the direct teaching operation.

The robot controller 4 includes an operation program generation unit 61 which has an operation program generation function of generating or modifying the operation program 32. In the direct teaching operation, when the operator applies a force to the component of the robot 1, the operation program generation unit 61 performs control of changing the position and the orientation of the robot 1 so that the component of the robot 1 moves in the direction in which the force is applied.

The robot 1 includes a force sensor 22 by which the operator detects the force applied to a component of the robot 1. The force sensor 22 is configured by including, for example, a torque sensor disposed for each drive shaft of the robot 1. Alternatively, the force sensor 22 can be configured by six-axis force sensors provided respectively in the base part 14, the turning base 13, the lower arm 12, the upper arm 11, and the wrist 15 of the robot 1. From the output of the force sensor 22, a magnitude of force, a magnitude of torque, a direction in which the force is applied, and a direction in which the torque is applied can be calculated.

The operation program generation unit 61 includes a force detection unit 62 which has a force detection function of detecting the magnitudes and the directions of the force and the torque that are applied to the component by the operator. The force detection unit 62 receives the output of the force sensor 22. The force detection unit 62 detects the magnitude and direction of an external force applied to the robot 1, based on the output of the force sensor 22. The force detection unit 62 further specifies a component of the robot 1 to which the external force is applied.

The operation program generation unit 61 includes a driven command unit 63 which has a driven command function of generating a command signal for driving the robot 1 based on the magnitude and orientation of the external force detected by the force detection unit 62. The driven command unit 63 generates a command signal for driving the robot 1 so that the component moves in the direction in which the operator applies a force. The driven command unit 63, at this time, may generate a command for the rotational speed of the robot drive motor 19 based on the magnitude of the force applied by the operator. The driven command unit 63 transmits a command signal for driving the robot drive motor 19 to the operation control unit 43. The operation control unit 43 drives the robot 1 based on the command signal from the driven command unit 63 during a period in which the direct teaching operation is performed.

In this way, the operator can directly operate the robot 1, and change the position and the orientation of the robot in order to generate teaching points. In the direct teaching operation of the present embodiment, the operator pushes and pulls the component of the robot 1, however, the direct teaching operation is not limited to this configuration. Any mechanism capable of performing the direct teaching operation can be employed. For example, a handle gripped by the operator can be fixed to the wrist via a force sensor. An external force applied by the operator is detected by the force sensor. The operator can change the position and the orientation of the robot by moving the handle.

The operation program generation unit 61 includes a state acquisition unit 66 which has a state acquisition function of acquiring the position and the orientation of the robot 1. The state acquisition unit 66 detects the position and the orientation of the robot 1 based on the output of the position detector 18 during a period in which the operator is moving the component of the robot 1. The operation program generation unit 61 includes a teaching point setting unit 67 which has a teaching point setting function of setting, as a teaching point, the position and the orientation of the robot 1 acquired by the state acquisition unit 66. The teaching point setting unit 67 sets one or more teaching points based on the position and the orientation of the robot 1. The operation program generation unit 61 includes a command generation unit 68 which has a command generation function of generating an operation command included in the operation program 32 based on the teaching point set by the teaching point setting unit 67. The operation program generation unit 61 includes a display control unit 69 which has a display control function of controlling an image displayed on the display part 50 of the teach pendant 49.

The operation program generation unit 61 corresponds to a processor driven based on the generation program 46. The processor reads the generation program 46 and performs control defined in the generation program 46, thereby serving as the operation program generation unit 61. Similarly, each of the state acquisition unit 66, the teaching point setting unit 67, the command generation unit 68, the display control unit 69, the force detection unit 62, and the driven command unit 63 corresponds to a processor driven based on the generation program 46. The processor serves as each unit by performing the control defined in the operation program 46. The operation control unit 43 also corresponds to a processor driven based on the generation program 46.

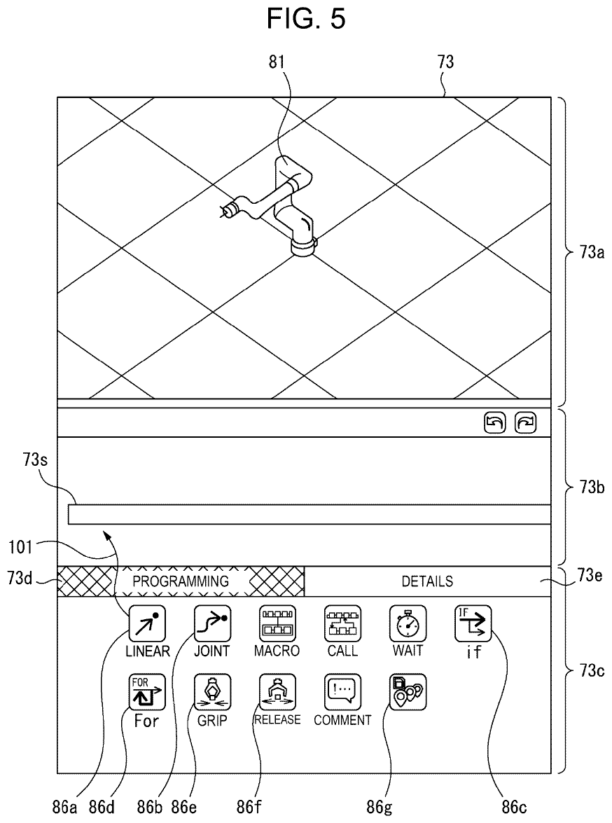

FIG. 5 illustrates an image for explaining a process of generating the first operation program in the present embodiment. FIG. 5 illustrates the image 73 when the generation of the operation program is started. The program display region 73b is in a state in which no operation program is displayed.

First, the operator selects the tab 73d for programming in the information display region 73c. The information display region 73c displays icons corresponding to various types of operation commands. The operation command includes commands related to the operation of the robot 1 such as the icons 86a and 86b. The icons 86a and 86b each correspond to one operation of the robot 1. The operation command includes the icon 86g for performing the direct teaching operation.

An icon 86c indicates an operation command for branching an operation according to a predefined condition. An icon 86d indicates an operation command for repeating the same operation at a predefined number of times. In this way, the operation command includes an icon for controlling an operation of the robot 1. An icon 86e is an operation command for the hand 2 for performing an operation of gripping a workpiece. An icon 86f is an operation command for the hand 2 for performing an operation of releasing the gripped workpiece. In this way, the operation command includes an icon for performing an operation of the working tool. The operation command further includes an icon for calling another program, an icon, etc. for temporarily stopping the robot, etc.

The operator selects a desired icon displayed in the information display region 73c. Here, the operator selects the icon 86a. The operator disposes the icon 86a on the timeline 73s as indicated by an arrow 101. The operator disposes icons that correspond to the operation commands of the robot 1 or the hand 2 in line on the timeline 73s.

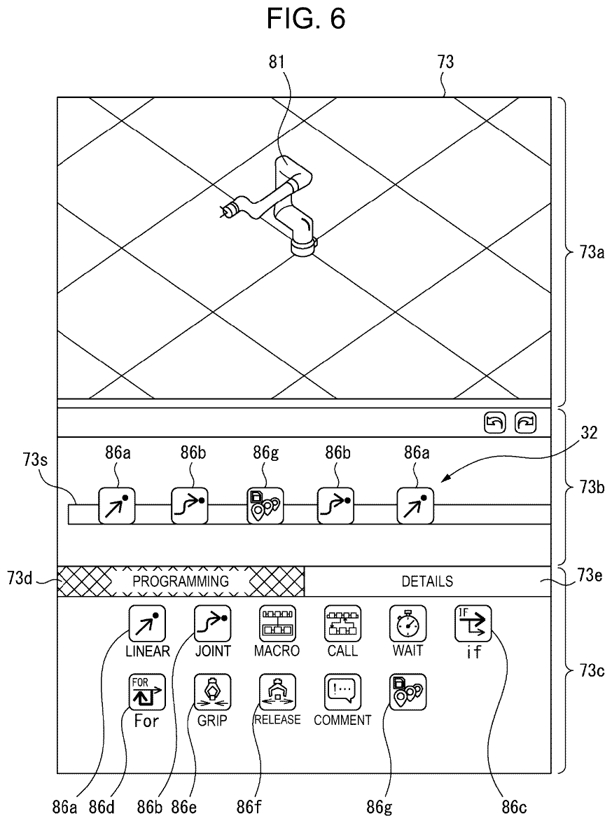

FIG. 6 illustrates an image when a plurality of icons are arranged in the program display region. In FIG. 6, the icon 86a, the icon 86b, the icon 86g for direct teaching, the icon 86b, and the icon 86a are disposed in order from the left. In this state, respective icons 86a, 86b and 86g do not have specific operation conditions set for the robot 1 and the hand 2. For example, position information such as coordinate values of a teaching point and a movement speed are not recorded. In this way, the display part 50 displays the first operation program 32 which includes the operation command for direct teaching before the position information of the teaching point is recorded.

For the icons 86a and 86b indicating a single operation command of the robot 1, the operation condition of the robot 1 can be set by selecting the tab 73e which indicates detailed information as described above (see FIG. 3). Furthermore, if the operation command of the working tool or the auxiliary device is disposed in the operation program, the operation condition of the working tool or the operation condition of the auxiliary device can be set by selecting the tab 73e.

Next, control for generating the operation commands of the robot which are included in the icon 86g for direct teaching will be described. In the teaching device of the present embodiment, a direct teaching operation can be started by selecting the icon 86g of the first operation program 32 in the program display region 73b and by performing a predetermined operation. For example, when the operator presses the icon 86g for a certain period of time, the display control unit 69 displays an image which indicates the start of the direct teaching operation. In this way, when the operation command for direct teaching in the first operation program 32 is selected, the direct teaching operation can be performed.

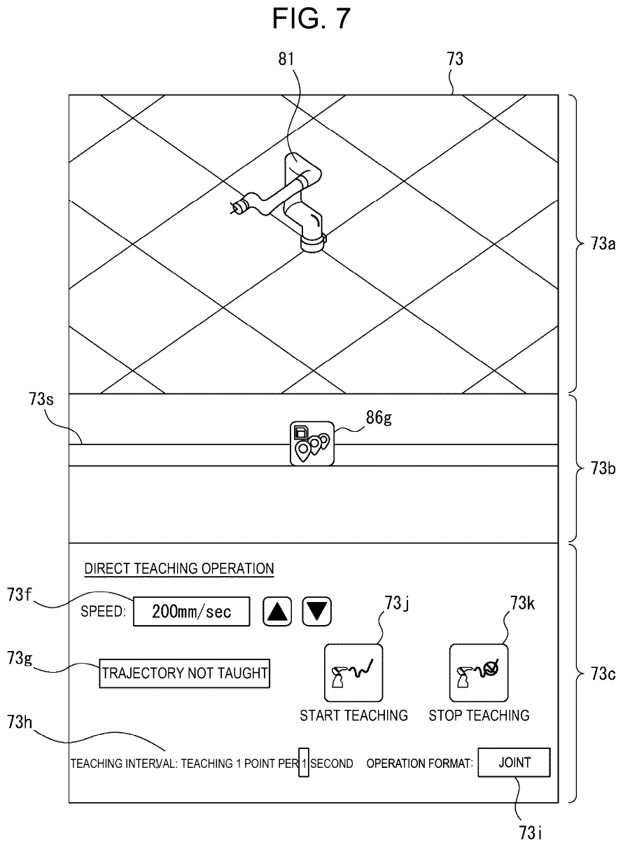

FIG. 7 illustrates an image of the start of the direct teaching operation. Only the icon 86g for direct teaching is displayed in the program display region 73b. The information display region 73c displays information such as a condition for performing the direct teaching operation. In this example, the information display region 73c displays a speed setting region 73f which sets the movement speed of the position (tool center point) of the robot in an operation command of the robot to be generated. The operator can set the movement speed of the position of the robot by operating a button disposed next to the speed setting region 73f.

An interval designation region 73h is displayed in the information display region 73c. In the present embodiment, the state acquisition unit 66 acquires the position and the orientation of the robot 1 for each predefined interval during a period in which the operator is changing the position and the orientation of the robot 1. Then, the teaching point setting unit 67 sets the acquired position and orientation of the robot as a teaching point. In this example, a teaching point is generated for each time interval designated in the interval designation region 73h.

The information display region 73c displays a format designation region 73i which designates an operation format of the robot 1 in an operation command of the robot to be generated. Here, a command for moving the tool center point in a curved manner is selected so that the trajectory of the robot 1 passes near a teaching point. This command corresponds to an operation command by the icon 86b. The command generation unit 68 generates the icon 86b among the plurality of types of icons. Other operation formats of the robot 1 include a format in which the tool center point moves in a linear manner so as to correspond to the icon 86a. Alternatively, other operation formats include a format in which the trajectory of the robot 1 is generated by a spline curve. In this way, the operator can designate in advance operation condition of the robot when an operation command of the robot is generated by the direct teaching.

The information display region 73c displays a drive information region 73g for displaying the current drive state of the robot 1. FIG. 7 illustrates an image before the direct teaching operation is performed. Therefore, the information display region 73g displays that no teaching points for generating the trajectory are taught.

The information display region 73c displays a button 73j used to start the teaching of the teaching points and a button 73k used to end the teaching of the teaching points. The operator starts the direct teaching operation by pressing the button 73j.

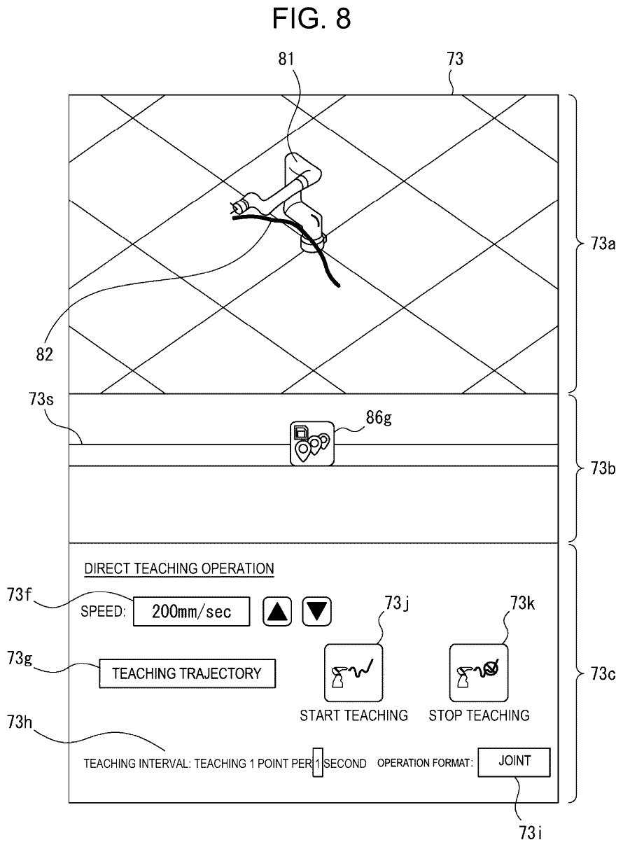

FIG. 8 illustrates an image during a period in which the direct teaching operation is being performed. The operator grips any component of the robot 1, and changes the position and the orientation of the robot so that the position of the robot moves along a desired trajectory. In this process, the force detection unit 62 detects an external force applied to the robot 1, based on the output of the force sensor 22. The driven command unit 63 drives the robot 1 so as to follow the operation of the robot 1 by the operator.

The drive information region 73g displays that the teaching point of the robot 1 is being taught. The state acquisition unit 66 detects the position and the orientation of the robot based on the output of the position detector 18. In this process, the state acquisition unit 66 acquires the position and the orientation of the robot for each time interval designated in the interval designated region 73h. Next, the teaching point setting unit 67 sets, as a teaching point, the position and the orientation of the robot 1 acquired by the state acquisition unit 66. The command generation unit 68 generates the icon 86b as an operation command for each teaching point. The command generation unit 68 associates information of the position and the orientation of the robot 1 with each icon 86b, and stores in the storage part 42.

In the trajectory display region 73a, the display control unit 69 displays an image 82 of the trajectory of the tool center point of the robot 1. The display control unit 69 displays the image 82 of the trajectory calculated based on the position and the orientation of the robot 1 acquired by the state acquisition unit 66.

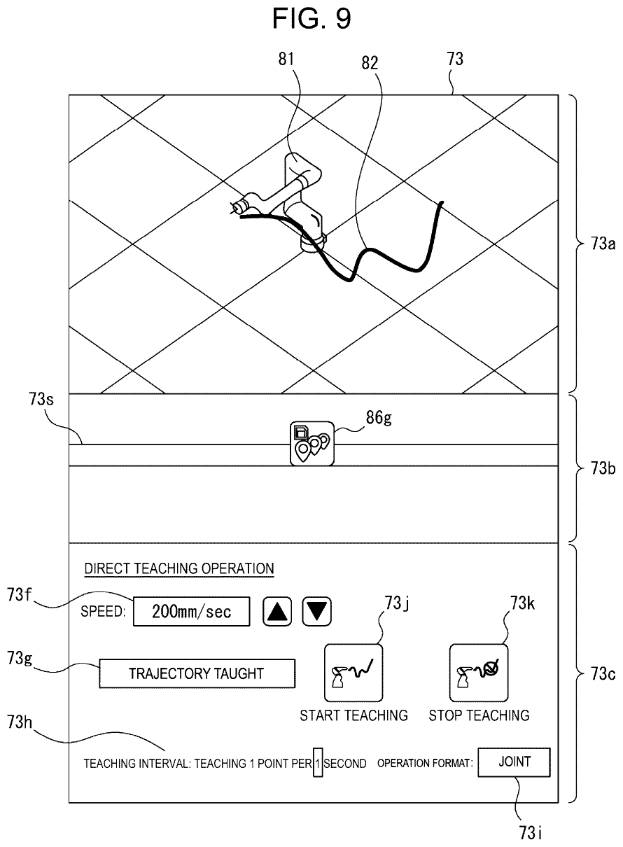

FIG. 9 illustrates an image after the teaching of the teaching points has ended. When the position and the orientation of the robot 1 reach a target position and orientation, the operator presses the button 73k to stop the teaching. With this, the teaching of teaching points in one section ends. The drive information region 73g of the information display region 73c indicates that the teaching of the teaching points has ended. The trajectory display region 73a displays the image 82 of the trajectory generated by the direct teaching operation. Here, by pressing the button 73j used to start the teaching, a teaching point may be added by performing the direct teaching operation again.

After the teaching of the teaching points in one section ends, the operator ends the direct teaching operation. In this example, when the operator presses the icon 86g for a certain period of time, the display control unit 69 displays the image 73 illustrated in FIG. 6. Since the teaching points are taught, the icon 86g includes a plurality of operation commands of the robot. In this way, the first operation program 32 can be generated by associating the operation conditions of the robot with icons as the respective operation commands.

Next, a method of checking and changing a plurality of operation commands of the robot included in the icon 86g as an operation command will be described. In the direct teaching operation, approximate position and orientation of the robot can be designated. However, designating an accurate position and orientation of the robot 1 may be difficult. Fine modification for the position and the orientation of the robot can be performed at each of the teaching points after the teaching points are set.

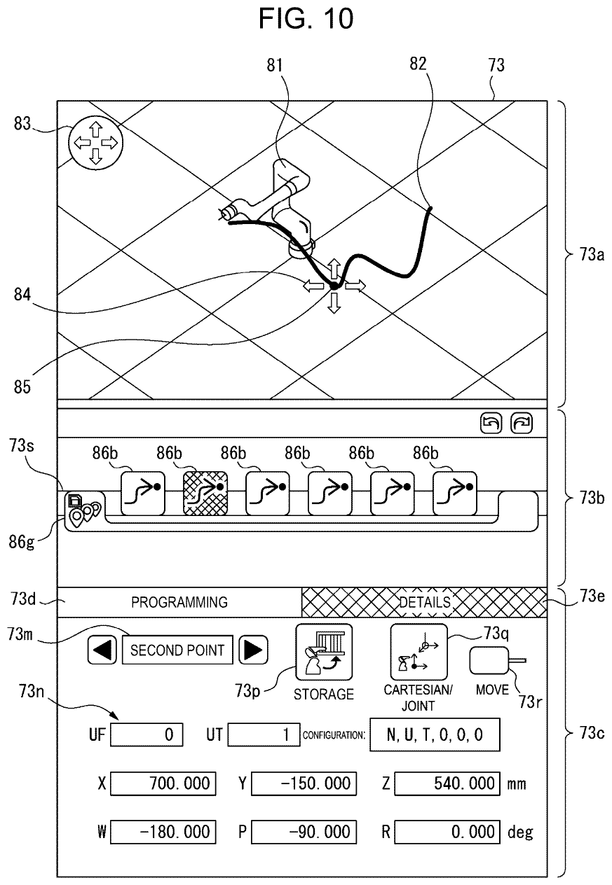

FIG. 10 illustrates an image when an icon of the robot included in the direct teaching icon is selected. As described above, by pressing the icon 86g included in the first operation program 32 twice in succession, the display control unit 69 expands and displays the icon 86g.

The icon 86g generated by the direct teaching operation includes a plurality of icons 86b. In the image 73 in FIG. 7 for starting the teaching of the teaching points, a control format of controlling the drive of each drive shaft is selected in the format designation region 73i. To this end, the command generation unit 68 generates the icons 86b which performs the control of moving the position of the robot 1 in a curved manner. Further, based on the designation of an interval in the interval designated region 73h, one icon 86b is generated per second. In this example, six icons 86b are generated.

Next, the operator selects one icon 86b in the program display region 73b. In the example illustrated in FIG. 10, the second icon 86b is selected among the plurality of icons 86b included in the icon 86g for direct teaching. When the operator selects the tab 73e for indicating detailed information, the information display region 73c displays detailed information of the second icon 86b.

The information display region 73c displays a selection region 73m used to select a teaching point. By pressing a button disposed next to the selection region 73m, one icon 86b can be selected from the plurality of icons 86b included in the icon 86g for direct teaching so as to display the detailed information.

Similar to the information display region 73c illustrated in FIG. 3, the teaching point information region 73n is displayed. The teaching point information region 73n displays the position and the orientation of the robot 1 at the teaching point set by the teaching point setting unit 67. The operator can modify the position and the orientation of the robot 1 by changing coordinate values displayed in the teaching point information region 73n.

In this example of the information display region, the button 73q for changing the coordinate system displayed in the teaching point information region 73n is displayed, similarly to the information display region 73c illustrated in FIG. 3. The button 73p for changing and storing the position and the orientation of the robot 1 at the teaching point is also displayed. The button 73r for driving the robot 1 is also displayed so as to achieve the position and the orientation of the robot 1 at the teaching point which corresponds to the selected icon 86b. The operator can use these buttons 73p, 73q and 73r when modifying the position and the orientation of the robot at the teaching point. In addition, in the information display region 73c of FIG. 10, the operation information region 73t for changing the movement speed and the operation format of the tool center point may also be formed, similarly to the information display region 73c illustrated in FIG. 3.

In the trajectory image 82 displayed in the trajectory display region 73a, an image 85 of the teaching point corresponding to the selected icon 86b is displayed, and a button 84 is displayed at the position of the teaching point. The button 84 includes arrows indicating a plurality of directions. The operator can press an arrow in a desired direction and move the position of the robot 1 in the direction of the pressed arrow. In other words, the position of the teaching point can be moved. A button 83 is also displayed in the trajectory display region 73a. The button 83 is a button for performing fine adjustment for the position of the robot 1. The operator can press an arrow included in the button 83 and move the position of the robot slightly in the direction of the pressed arrow.

The trajectory display region 73a may also display a button for modifying the orientation of the robot. As described above, the position and the orientation of the robot can be modified by operating a button displayed in an image of the trajectory of the robot.

The operator can select an icon corresponding to a teaching point in the selection region 73m and check or change the position and the orientation of the robot included in each operation command of the robot. After completing the check or change of one teaching point, the operator can select another teaching point and check or change the selected teaching point. In this way, the position and the orientation of the robot can be modified for icons generated by the direct teaching operation. In addition, the operator may select the tab 73d for programming and add a new icon to a section designated by the icon 86g for direct teaching.

In the teaching device of the present embodiment, the display part 50 displays the first operation program 32 including the icon 86g as the operation command for direct teaching. The icon 86g at this time is in a state before the position information of the teaching point is recorded. The operator starts the direct teaching operation by selecting the icon 86g for direct teaching. The command generation unit 68 generates the icon 86g in which the position information of the teaching point is recorded. As the direct teaching operation can be started in this way from the first operation program 32, the operator can easily perform the direct teaching operation. The operator does not need to switch many images in order to perform the direct teaching operation, and an operation program can be generated easily.

The command generation unit 68 further generates icons 86b as a plurality of operation commands of the robot 1 based on a plurality of teaching points. The command generation unit 68 also generates one direct teaching icon 86g including the plurality of icons 86b of the robot. The display part 50 displays the direct teaching icon 86g.

In this way, the operation command for direct teaching of the present embodiment can be displayed in one operation command Therefore, when viewing an operation program, the operator can easily determine a section, in which the direct teaching operation is performed. The operator can easily create or delete a section taught by the direct teaching operation. For example, all operation commands of the robot in one section in which the direct teaching operation is performed may need to be changed. In this case, the operator can delete a direct teaching icon without the need of changing the operation conditions of each and every icons of the robot. Thereafter, the operator can generate a new direct teaching icon by performing the direct teaching operation. In this way, the operator easily generates an operation program.

When a direct teaching operation is performed, many icons corresponding to the teaching points may be generated. As a result, an operation program may become very long and degrade in visibility. By displaying a direct teaching icon including a plurality of icons of the robot, an operation program can be prevented from becoming too long.

In the above embodiment, when the operator performs an operation of expanding a direct teaching icon of an operation program, the display part expands the direct teaching icon and displays a plurality of icons of the robot included in the direct teaching icon. By employing this configuration, detailed information of each icon generated by the direct teaching operation can be checked or modified.

The generation program 46 as a computer program of the present embodiment can cause an arithmetic processing device to serve as the operation program generation unit 61 so as to facilitate the generation of an operation program as described above. Particularly, the generation program 46 can cause a computer to execute at least one function among: the input function of the input part 51; the display function of the display part 50; the state acquisition function of the state acquisition unit 66; the teaching point setting function of the teaching point setting unit 67; the command generation function of the command generation unit 68; and the display control function of the display control unit 69.

In the above embodiment, the icon 86g in the first operation program 32 is deformed so as to display the icons 86b for a plurality of operations of the robot, but is not limited to this configuration. A direct teaching icon may be formed so as to always display a plurality of icons of the robot without deformation.

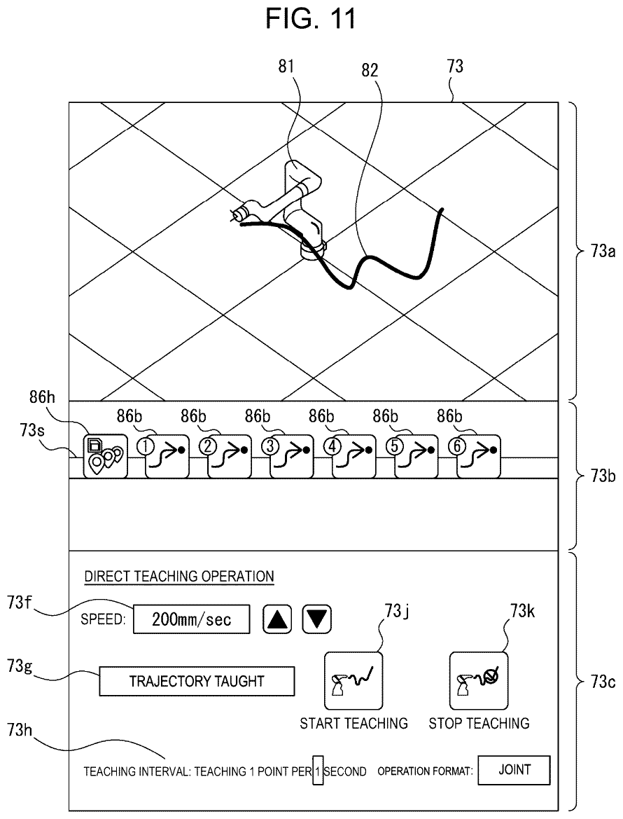

FIG. 11 illustrates an image displaying another direct teaching icon. FIG. 11 illustrates an image when the operator has ended changing the position and the orientation of the robot. The drive information region 73g of the information display region 73c indicates that the teaching of the teaching points has ended. A direct teaching icon 86h does not collectively display the plurality of icons 86b of the robot, but displays a plurality of icons 86b of the robot generated by the direct teaching operation in line. Also, number in the order of generation is displayed in each of the plurality of icons 86b. Here, six icons of the robot are generated by the direct teaching operation. In this way, the direct teaching icon may not designate or may not merge a plurality of icons indicating operations of the robot.

In the first operation program 32, each operation command is displayed as an icon representing a command diagram. Therefore, the operator can easily find an operation command for direct teaching. For example, the operator can easily find a direct teaching icon from a plurality of icons by viewing the icon diagrams. This facilitates the generation of an operation program.

Next, a second operation program in the present embodiment will be described. In the second operation program, the operation command of an operation program is configured by a command statement. The configuration of a robot controller serving as a teaching device is similar to that of the robot controller 4 that generates the first operation program (see FIG. 2). The display control unit 69 displays a second operation program 33, instead of the first operation program 32, on the display part 50.

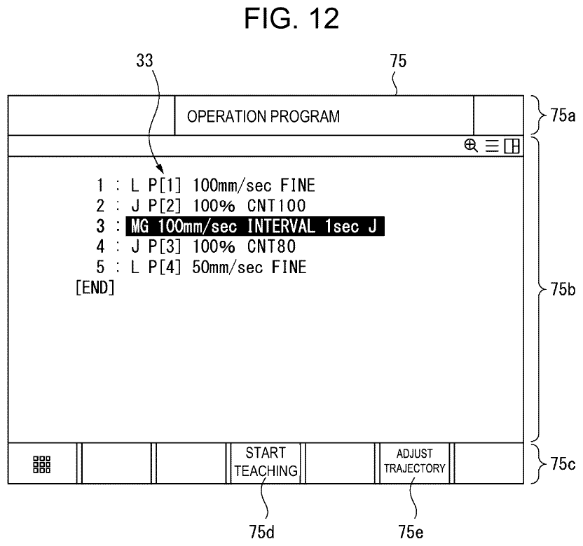

FIG. 12 illustrates an image displaying the second operating program in the present embodiment. An image 75 includes a title region 75a for displaying the name of an image, a program display region 75b for displaying the second operation program 33, and a button region for displaying buttons used when the operator performs an operation. In the second operation program 33, an operation command is configured by a command statement. In the second operation program 33, one command statement is described in one row. When the second operation program 33 and the first operation program 32 are compared with each other, one icon in the first operation program 32 corresponds to one command statement.

Each command statement in the first row, the second row, the fourth row and the fifth row of the second operation program 33 indicates one operation command of the robot 1. A symbol L indicates a command for linearly moving the position of the robot. The symbol L corresponds to the operation command in the icon 86a of the first operation program 32 (see FIG. 3). A symbol J indicates a command for moving the position of the robot in a curved manner by driving the drive shafts of the robot 1. The symbol J corresponds to the icon 86b of the first operation program 32 (see FIG. 3). In each command statement, a teaching point is indicated using the symbol P. Here, P[1], P[2], P[3] and P[4] are set as teaching points. The position and the orientation of the robot 1 at each teaching point are stored in association with the command statement.

Each command statement indicates the movement speed of the position of the robot. For example, the command statement in the first row indicates that the movement speed of the position (tool center point) of the robot is 100 mm/sec. The command statement in the second row indicates that each drive shaft is driven at 100% of the maximum speed of each drive shaft. A symbol FINE indicates that the robot is driven with high accuracy with respect to the teaching point. That is, the position and the orientation of the robot 1 are changed so as to pass through the respective teaching points. A symbol CNT is a variable indicating the smoothness of a curve. The symbol CNT indicates a variable of a distance that may be away from the teaching point.

The second operation program 33 includes an operation command for direct teaching in the third row, similarly to the first operation program 32. A symbol MG indicates the operation command for direct teaching. Here, it is defined that a command statement is generated so that the movement speed of the tool center point is 100 mm/sec. A symbol INTERVAL designates a time interval for acquiring one teaching point. Here, the time interval is described so that the teaching point is acquired at a rate of one per second. In other words, one command statement is generated every second. Further, the symbol J in this line designates that a command for moving the position of the robot 1 in a curved manner by driving each drive shaft of the robot is generated. The command statement in the third row corresponds to the icon 86g for direct teaching in the first operation program 32 (see FIG. 3).

In the second operation program 33, the operation command for direct teaching includes a plurality of operation commands of the robot 1, similarly to the first operation program 32. The display part 50 can display an operation command for direct teaching configured by one command statement. Further, the operator can start a direct teaching operation from the command statement for direct teaching included in the second operation program 33.

The operator generates the command statement for direct teaching illustrated in FIG. 12 by operating the input part 51. In this stage, the command statement for direct teaching is in a state where the position information of the teaching point is still not recorded. The operator selects the command statement for direct teaching in the program display region 75b. Then, when the operator presses a button 75d for the start of the teaching displayed in the button region 75c, the direct teaching operation is started.

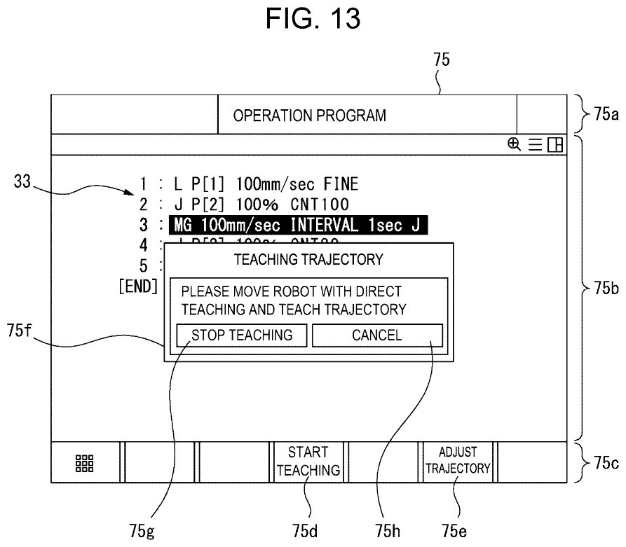

FIG. 13 illustrates an image during a period in which the direct teaching operation is being performed. The program display region 75b displays an image 75f for notifying that the direct teaching operation is being performed. The operator changes the position and the orientation of the robot 1 to a target position and a target orientation, respectively, by moving the component of the robot 1. The state acquisition unit 66 acquires a position and an orientation of the robot for each designated time interval. The teaching point setting unit 67 sets a teaching point based on the position and the orientation of the robot acquired by the state acquisition unit 66. Then, the command generation unit 68 generates a plurality of command statements of the robot according to the command statement for direct teaching. Then, the command generation unit 68 generates an operation command of the robot in which the position information of the teaching point is recorded. Each command statement of the robot is stored in the storage part 42 in association with the command statement for direct teaching.

The image 75f displays a button 75g used to end the teaching of the teaching points and a button 75h used to cancel the teaching of the teaching points. When the change in the position and the orientation of the robot has ended, the operator presses the button 75g to end the teaching of the teaching points. The button 75h is a button to discontinue the teaching that is currently performed. By pressing the button 75h, teaching points and operation commands of the robot that are already generated are erased, and the direct teaching operation ends.

When the position and the orientation of the robot are taught and the direct teaching operation ends, the process is returned to the image 75 illustrated in FIG. 12. The operator then checks the command statement of the robot generated by the direct teaching operation. Alternatively, the operator may modify the command statement of the robot. In the second operation program 33, the command statement for direct teaching including a plurality of command statements of the robot is also displayed in one command statement just like the first operation program. When the operator inputs a command to expand the operation command for direct teaching, the display part 50 displays the plurality of command statements of the robot included in the operation command for direct teaching. The operator then selects the command statement for direct teaching in the third row, and presses the button 75e in the button region 75c to adjust the trajectory. With this, a plurality of operation commands included in the operation command for direct teaching can be displayed.

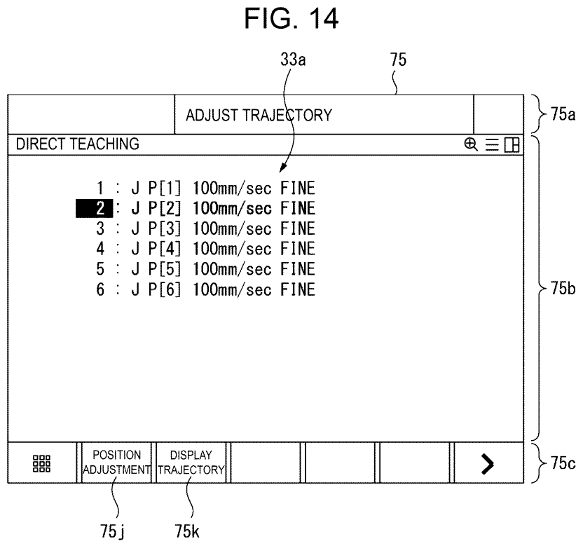

FIG. 14 illustrates an image in which the plurality of command statements of the robot included in the command statement for direct teaching are displayed. The program display region 75b displays information 33a of the operation commands of the robot included in the operation command for direct teaching. Here, the command statement for direct teaching includes six command statements of the robot. In each command statement, an operation command for driving each axis is generated according to the trajectory of the command statement for direct teaching in the third row illustrated in FIG. 12.

With the display in FIG. 14, the operator can change the operation condition of the robot in each command statement of the robot. Here, the operator has selected the command statement of the robot in the second row. The operator presses a button 75j in the button region 75c for position adjustment.

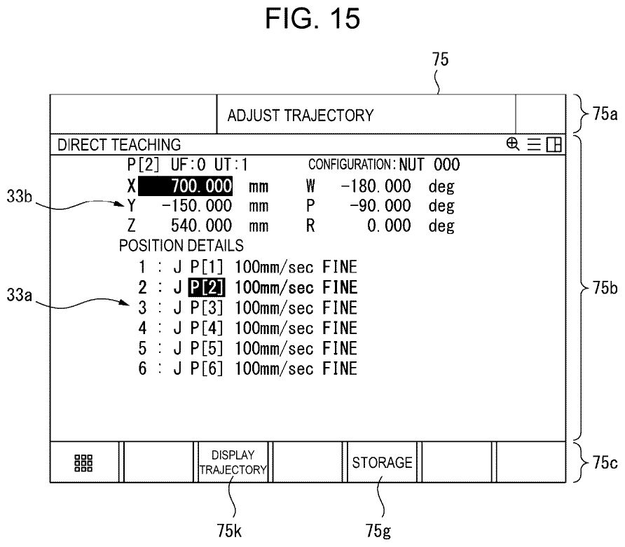

FIG. 15 illustrates an image when the operator selects the command statement of the robot and presses the button for position adjustment. The display control unit 69 displays the operation condition of the robot at the selected second teaching point. The program display region 75b displays the information 33a of the operation command of the robot included in the current operation command for direct teaching. The program display region 75b also displays information 33b of the position and the orientation of the robot which is set in a user coordinate system.

The operator can change the information 33b of the position and the orientation of the robot by operating the input part 51 and inputting respective coordinate values. Alternatively, when the operator presses the button 75g for position teaching displayed in the button region 75c, the position and the orientation of the robot 1, which have been changed by the operation of the teach pendant 49, can be overwritten on the information 33b. This can be operated as the following. The operator adjusts the position and the orientation of the robot 1 by operating the input part 51 of the teach pendant 49. Each coordinate value of the position and the orientation in the information 33b is changed. When the robot is in a desired position and orientation, the current coordinate value is stored by pressing the button 75g for storage.

Also in the second operation program 33, similarly to the first operation program 32, after the teaching point is taught by the direct teaching operation, the position and the orientation of the robot at the teaching point can be finely adjusted. The setting or modification of such detailed operation conditions can be performed for each command statement of the robot. Further, with reference to FIGS. 14 and 15, by pressing a button 75k for trajectory display displayed in the button region 75c, the image of the trajectory of the robot can be displayed.

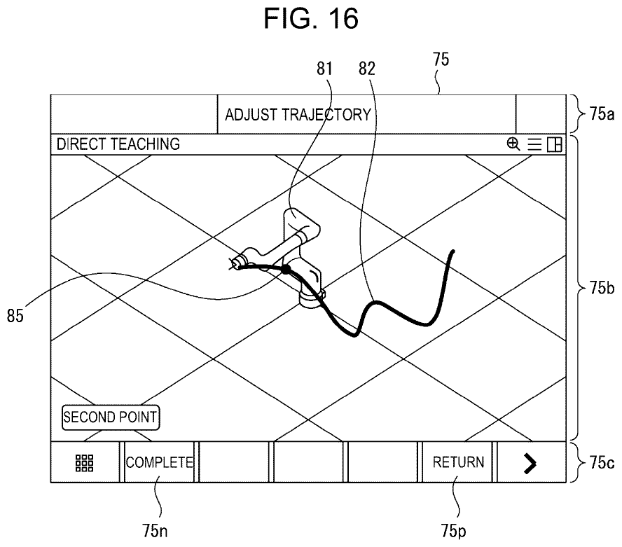

FIG. 16 illustrates an image in which the trajectory of the robot is displayed. Here, the program display region 75b displays the image 81 of the robot and the image 82 of the trajectory. The program display region 75b further displays the image 85 of the second teaching point selected in FIG. 14. In this way, also in the second operation program, the trajectory of the robot can be checked in the image. In addition, as illustrated in the image 73 of FIG. 10, the buttons 83 and 84 for adjusting the position and the orientation of the robot may be displayed. The program display region 75b may be formed so that the position and the orientation of the robot can be adjusted by operating a button displayed on an image including the robot.

In this way, the operation command of the robot included in the operation command for direct teaching can be changed. In addition, the information 33a on the operation command of the image 75 in FIG. 15 may be formed so that the operation format of the robot defined by the symbol L or the symbol J and the movement speed of the robot can be changed.

The state acquisition unit 66 of the teaching device of the present embodiment acquires the position and the orientation of the robot related to the teaching point for each predefined time interval, but is not limited to this configuration. The state acquisition unit can acquire the position and the orientation of the robot at arbitrary intervals. For example, the state acquisition unit may acquire the position and the orientation of the robot for each predefined movement distance of the position of the robot. That is, the state acquisition unit may acquire the position and the orientation of the robot each time the tool center point moves a predefined distance.

The teaching point setting unit of the present embodiment sets, as teaching points, all positions and orientations of the robot acquired by the state acquisition unit, but is not limited to this configuration. The teaching point setting unit may select some of the positions and orientations of the robot among a plurality of positions and orientations of the robot, and generate teaching points. The teaching point setting unit can set one or more teaching points.

For example, in the operation program, it is preferable that the number of operation commands such as command diagrams or command statements be small. In view of this, the teaching point setting unit calculates the trajectory of the robot generated for all teaching points acquired by the state acquisition unit and the trajectory of the robot generated for some of the teaching points. The teaching point setting unit can select some teaching points so that an error (distance) between the two trajectories is less than a predefined determination value. In other words, the teaching point setting unit can delete some of the teaching points so that an error of the trajectory of the robot is within a predetermined range. The command generation unit can generate operation commands that correspond to the teaching points selected by the teaching point setting unit.

In the present embodiment, the arithmetic processing device of the controller body 5 has the functions of the operation program generation unit 61 and the storage part 42 that stores the generation program 46, but is not limited to this configuration. The teach pendant may include the arithmetic processing device, and may have the function of the operation program generation unit and the function of the storage part that stores the generation program. Alternatively, in addition to the controller body and the teach pendant, an arithmetic processing device may be connected to the robot controller and the arithmetic processing device may have the function of the operation program generation unit and the function of the storage part that stores the generation program.

In each of the above-described controls, the order of steps can be changed appropriately to the extent that the function and the effect are not changed.

The above-described embodiments can be suitably combined. In each of the above drawings, the same or similar parts are denoted by the same reference numerals. It should be noted that the above-described embodiments are examples and do not limit the invention. Further, the embodiments include modifications of the embodiments illustrated in the claims.

### REFERENCE SIGNS LIST

1 Robot
4 Robot controller
32 First operation program
33 Second operation program
42 Storage part
43 Operation control unit
46 Generation program
49 Teach pendant
50 Display part
51 Input part
61 Operation program generation unit
67 Teaching point setting unit
68 Command generation unit
73 Image
75 Image
86a to 86h Icon

1-9. (canceled)

10. A controller comprising:
at least one memory configured to store an operation program;
a display capable of displaying the operation program; and
at least one processor,
wherein the operation program includes a first operation command indicating a direct teaching operation and at least one second operation command,
the at least one processor is configured to:
generate, after receiving an input of the first operation command, the at least one second operation command in the first operation command, based on information of a position and an orientation of a robot acquired during a period in which the direct teaching operation by an operator is received, and
display the first operation command and/or the at least one second operation command on the display in line in order of execution of the operation program.

11. The controller of claim 10, wherein the first operation command is configured by one command statement or one command diagram, and the at least one second operation command is configured by at least one command statement or at least one command diagram.

12. The controller of claim 10, wherein the first operation command includes the at least one second operation program.

13. The controller of claim 10, wherein the at least one processor is configured to:
set a teaching point based on the information of the position and the orientation acquired for each predefined interval; and
generate the at least one second operation command based on the teaching point.

14. The controller of claim 10, wherein the at least one processor is configured to display the first operation command and the at least one second operation command on the display in line.

15. The controller of claim 10, wherein the at least one processor is configured to expand, after receiving information of an operation input to the display or an input part by the operator, the first operation command based on the received information of the operation input, and display the at least one second operation command included in the first operation command.

16. The controller of claim 10, wherein the at least one processor is configured to generate the at least one second operation command based on an operation condition of the robot and/or a trajectory of the robot in response to the direct teaching operation by the operator.

17. The controller of claim 10, wherein the operation program includes another operation command different from the first operation command and the at least one second operation command.

18. The controller of claim 10, wherein the at least one processor is configured to modify, after receiving information of an operation input to the display or an input part by the operator, the first operation command or the generated at least one second operation command based on the received information.

19. The controller of claim 10, wherein each operation command of the first operation command and the at least one second operation command is displayed as an icon on the display.

20. The controller of claim 10, wherein the at least one memory is configured to store information of an image of the robot, and the at least one processor is configured to:
display the image of the robot on the display;
generate a trajectory based on the information of the position and the orientation acquired for each predefined interval; and
superimpose the trajectory on the image of the robot and display the trajectory on the display.

21. The controller of claim 10, wherein the trajectory is configured based on the at least one second operation command.

22. The controller of claim 20, wherein the at least one processor is configured to display, after receiving a designation of the at least one second operation command by an operation input of the operator, positional information corresponding to the designated at least one second operation command on the trajectory.

23. A teaching device comprising:
at least one memory configured to store an operation program; and
at least one processor,
wherein the operation program includes a first operation command indicating a direct teaching operation and at least one second operation command,
the at least one processor is configured to:
generate, after receiving an input of the first operation command, the at least one second operation command in the first operation command, based on information of a position and an orientation of a robot acquired during a period in which the direct teaching operation by an operator is received, and
display the first operation command and/or the at least one second operation command on the display in line in order of execution of the operation program.

24. A non-transitory storage medium storing a computer program of a controller for causing at least one processor to execute the computer program, the computer program comprising the steps of:
display an operation program stored in a memory on a display;
generate, after receiving an input of a first operation command indicating a direct teaching operation, at least one second operation command in the first operation command, based on information of a position and an orientation of a robot acquired during a period in which the direct teaching operation by an operator is received; and
display the first operation command and/or the at least one second operation command on the display in line in order of execution of the operation program,
wherein the operation program includes the first operation command and the at least one second operation command.
